(19) United States
(12) Patent Application Publication
(10) Pub. No.: US 2019/0389692 A1
(43) Pub. Date: Dec. 26, 2019

(54) ELEVATOR DISPATCHING

(71) Applicant: Otis Elevator Company, Farmington, CT (US)

(72) Inventors: Derk Pahlke, Berlin (DE); Mario Pink, Berlin (DE); Arthur Hsu, South Glastonbury, CT (US)

(21) Appl. No.: 16/443,430

(22) Filed: Jun. 17, 2019

(30) Foreign Application Priority Data
Jun. 21, 2018 (EP) 18179062.7

(51) Int. Cl. B66B 1/46

(52) U.S. Cl. CPC B66B 1/468; B66B 2201/4615

(57) ABSTRACT

An elevator system (2) comprises at least one elevator car (6) configured for traveling along a hoistway (4) between a plurality of landing area (8a, 8b, 8c) areas (8a, 8b, 8c) located at different floors (13a, 13b, 13c). A method of controlling movement of at least one elevator car (6) in the elevator system (2) comprises receiving on at least a subset of the floors (13a, 13b, 13c) from a mobile device (24a-24e) a radio signal representative of the number of potential passengers (22) on the respective floor (13a, 13b, 13c), and controlling movement of the elevator car (6) based on the received radio signals.

### FOREIGN PRIORITY

This application claims priority to European Patent Application No. 18179062.7, filed Jun. 21, 2018, and all the benefits accruing therefrom under 35 U.S.C. § 119, the contents of which in its entirety are herein incorporated by reference.

### BACKGROUND

The invention relates to a method of controlling the movement of at least one elevator car moving in an elevator system along a hoistway extending between a plurality of landing areas located at different floors. The invention is further related to an elevator control system configured for controlling the movement of the at least one elevator car, to an elevator system comprising such an elevator control system, and to a mobile device configured for being used in combination with such an elevator (control) system.

Elevator systems usually comprise landing control panels provided at the landing areas. The landing control panels include hall call buttons allowing passengers to request service by an elevator car. Instead or in addition to the hall call buttons, which allow requesting upward and downward service, the landing control panels may comprise destination call buttons allowing passengers to enter their desired destinations before entering the elevator car. Employing destination call buttons allows for a better dispatching of the elevator car(s) resulting in an improved response to passenger service requests and enhancing the efficiency of the elevator system.

Passengers, however, typically need to reach a landing area in order to activate a hall call button and/or destination call button. Only after a passenger has activated one of the hall call buttons and/or destination call buttons, is the elevator system aware of the presence of the passenger at the landing area and his/her desire to use the elevator system. Only then will the elevator system start moving an elevator car towards the respective landing. Thus, after having pressed a hall call button and/or destination call button, passengers usually have to wait some time before an elevator car reaches their landing area.

It would be beneficial to reduce the time passengers have to wait until an elevator car reaches their landing area.

### BRIEF DESCRIPTION

Exemplary embodiments of the invention include a method of controlling movement of at least one elevator car in an elevator system, wherein the at least one elevator car is configured for traveling along a hoistway between a plurality of landing areas located at different floors. The method includes receiving on at least a subset of the floors from a mobile device a radio signal representative of the number of potential passengers on the respective floor, and controlling movement of the elevator car based on at least one received radio signal.

In the context of the present invention, the “subset of floors” usually comprises every floor to and from which passengers are transported during normal operation of the elevator system. In addition to these floors, there may be “special floors”, such as maintenance floors, VIP floors, personnel floors etc., which are not included in the normal dispatching of the elevator car(s). It is possible that no radio receivers are provided on such “special floors” and thus no radio signals are received on said “special floors”.

In other words, there may be a first subset of floors and a second subset of floors. Radio receivers are installed on each floor of the first subset of floors, but no radio receivers are installed on the floors of the second subset. In consequence potential passengers present on the floors of the second subset are not taken into account when dispatching the elevator car(s) according to an exemplary embodiment of the invention.

Exemplary embodiments of the invention further include a mobile device configured for communicating with an elevator control system. The mobile device is configured for receiving radio signals from other mobile devices being present within a certain distance from the mobile device, and for emitting a radio signal comprising 25 information related to the number of other mobile devices from which radio signals have been received. The mobile device in particular may be a smartphone, tablet, laptop, smartwatch, or other known portable electronic device running an appropriate computer program (“App”).

Exemplary embodiments of the invention therefore also include computer program (“App”) configured for being executed on a mobile device such as a smartphone, tablet, laptop, smartwatch, or other known portable electronic device, and in particular a smart phone. The computer program, when executed, causes the mobile device to act as a mobile device according to an exemplary embodiment of the invention.

Exemplary embodiments of the invention further include an elevator control system configured for controlling an elevator system, the elevator system comprising at least one elevator car configured for traveling along a hoistway between a plurality of floors.

The elevator control system comprises a plurality of radio receivers. At least one radio receiver is arranged on each floor of at least a subset of the floors of the elevator system, and each radio receiver is configured for receiving radio signals emitted from a mobile device according to an exemplary embodiment of the invention.

The elevator control system further comprises a dispatcher configured for generating control signals controlling the movement of the elevator car based on the received radio signals for improving the response of the elevator system to passenger service requests and enhancing the efficiency of the elevator system. The dispatcher in particular may be configured for determining the number and/or the spatial distribution of potential passengers on each of the floors of the subset of floors equipped with receives and controlling the movement of the elevator car based on said distribution.

Exemplary embodiments of the invention also include an elevator system comprising at least one elevator car configured for traveling along a hoistway between a plurality of floors, and an elevator control system according to an exemplary embodiment of the invention.

Exemplary embodiments of the invention allow controlling the movement of the at least one elevator car based on the distribution of potential passengers over the floors. Exemplary embodiments of the invention in particular allow moving at least one elevator car to a crowded floor even before a hall call button and/or destination call button on the respective floor has been activated. As a result, the waiting times of the passengers at the landing areas are reduced and the efficiency of the elevator system is enhanced.

A number of optional features are set out in the following. These features may be realized in particular embodiments, alone or in combination with any of the other features. For enhancing the efficiency of the data transmission and reducing the load on the mobile devices, the received and emitted radio signals may be signals which do not require performing a handshake mechanism for establishing a data connection. The received and emitted radio signals in particular may include Bluetooth-low-energy® (BLE) radio signals and/or Wi-Fi beacon frames.

The received radio signal may comprise information indicating a spatial distribution of potential passengers on the respective floor. This allows determining whether a large number of potential passengers is located close to the landing area, or whether most of the potential passengers are still situated in some distance from the landing area.

The method may further include determining a change of the spatial distribution of potential passengers on the respective floor over time, i.e. determining whether the potential passengers present on a respective floor (on average) are approaching the landing area or are moving away from the landing area.

Determining the spatial distribution of potential passengers on the respective floor, in particular a change of said spatial distribution, allows optimizing the dispatching of the elevator cars even further. It in particular allows preventing elevator cars from being moved to a floor crowded with persons which do not intend to use the elevator system in the near future, since the determined spatial distribution, in particular the change of the spatial distribution over time, indicates that the persons are not approaching the landing area on the respective floor.

The at least one mobile device may receive radio signals from at least one other (similar) mobile device. The radio signals received from the at least one other mobile device may comprise an identifier, which allows unambiguously identifying the at least one other mobile device. The received radio signals further comprise information about the number of further mobile devices from which radio signals have been received by the at least one other mobile device emitting the radio signals. This allows determining the spatial distribution of mobile devices on the respective floor indicating the number of persons on the respective floor. The method in particular may include summing up the numbers of mobile devices comprised in the received radio signals, and including the sum into the emitted radio signal.

For reducing the average waiting time of the passengers and enhancing the efficiency of the elevator system, the dispatcher of an elevator control system according to an exemplary embodiment of the invention may be configured for controlling the elevator system so that at least one elevator car is moved to the landing area for which the largest number of potential passengers has been detected as being present in the vicinity of the landing area.

Alternatively or additionally, the dispatcher also may be configured for controlling the elevator system so that at least one elevator car is moved to a landing area for which the largest number of potential passengers has been detected as approaching the landing area.

### DRAWING DESCRIPTION

Exemplary embodiments of the invention are described in more detail with respect to the enclosed figures.

FIG. 1 depicts a schematic view of an elevator system according to an exemplary embodiment of the invention.

FIG. 2 depicts a schematic plane view of one of the floors of the elevator system.

FIG. 3A depicts ab exemplary distribution of mobile devices on a first floor at a first time.

FIG. 3B depicts ab exemplary distribution of mobile devices on a second floor at the first time.

FIG. 4A depicts ab exemplary distribution of mobile devices on a first floor at the second time different from first time.

FIG. 4B depicts ab exemplary distribution of mobile devices on the second floor at the second time.

### DETAILED DESCRIPTION

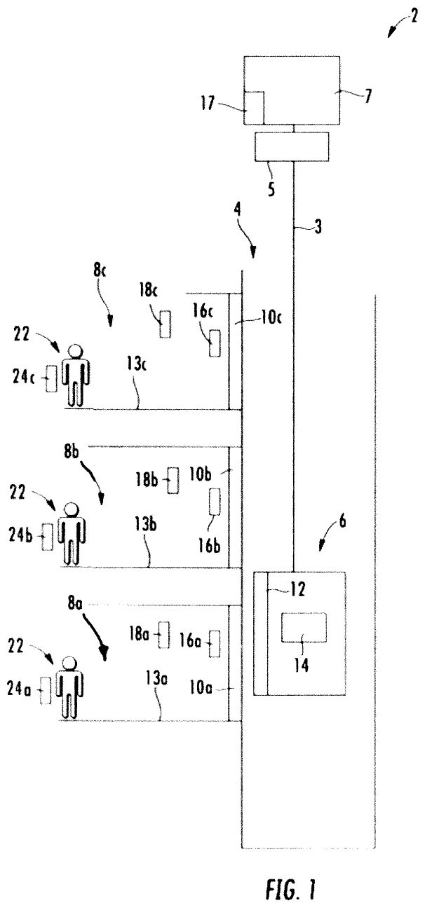

FIG. 1 depicts an elevator system 2 according to an exemplary embodiment of the invention.

The elevator system 2 includes an elevator car 6 which is movably suspended within a hoistway 4 by means of at least one tension member 3. The tension member 3, for example a rope or belt, is connected to an elevator drive 5, which is configured for driving the tension member 3 in order to move the elevator car 6 along the height of the hoistway 4 between a plurality of landing areas 8a, 8b, 8c located on different heights.

Each landing area 8a, 8b, 8c is provided with a landing door 10a, 10b, 10c, and the elevator car 6 is provided with a corresponding elevator car door 12 for allowing passengers to transfer between a landing area 8a, 8b. Be and the interior of the elevator car 6 when the elevator car 6 is positioned at the respective landing area 8a, 8b, 8c.

The exemplary embodiment shown in FIG. 1 uses a 1:1 roping for suspending the elevator car 6. The skilled person, however, easily understands that the type of the roping is not essential for the invention and that different kinds of roping, e.g. a 2:1 roping, 4:1 roping, etc. are possible as well. Optionally, the elevator system 2 may use a counterweight (not shown) attached to the tension member 3 for moving concurrently and in opposite direction with respect to the elevator car 6. The elevator drive 5 may be any form of drive used in the art, e.g. a traction drive, a hydraulic drive, or a linear drive. The drive system may use a tension member, like a rope or a belt or may be a rope less drive system. The elevator system 2 may have a machine room or may be a machine room-less elevator system.

The elevator drive 5 is controlled by a controller 7 for moving the elevator car 6 between the different landing areas 8a, 8b, 8c.

Input to the controller 7 may be provided via an elevator car control panel 14 provided inside the elevator car 6 and landing control panels 16a, 16b, 16c provided next to the landing doors 10a, 10b, 10c on each landing area 8a, 8b, 8c. The landing control panels 16a, 16b, 16c may comprise up and down hall call buttons and/or destination call buttons.

The elevator car control panel 14 and the landing control panels 16a, 16b, 16c may be connected to the controller 7 by means of electrical lines, which are not shown in FIG. 1, in particular by an electric bus, or by wireless connections.

Further, at least one radio receiver 18a, 18b, 18c is arranged on each of the floors 13a, 13b, 13c. Optionally, there may be additional floors (not shown) without a radio receiver 18a, 18b, 18c.

Each radio receiver 18a, 18b, 18c is configured for receiving radio signals emitted from mobile devices 24a, 2 4b, 24c, such as smart phones, carried by potential passengers 22 being present on the respective floors 13a, 13b, 13c.

In order to enhance the efficiency of the data transmission and reduce the load on the mobile devices 24a, 24b, 24c, the received and emitted radio signals may include Bluetooth®, in particular Bluetooth-low-energy (BLE) radio signals, GPS signal, cellular communication signals, RFID signals, zigbee signals, zWave signals and/or WiFi, in particular Beacon-WiFi radio signals, which do not require performing a handshake mechanism for establishing a data connection.

The radio receivers 18a, 18b, 18c are configured for transmitting the received signals by means of electrical lines, which are not shown in FIG. 1, in particular by an electric bus, or by wireless connections to a dispatcher 17 associated with the controller 7. The dispatcher 17 may be integrated with or provided separately of the controller 7.

The dispatcher 17 is configured for evaluating the signals received from the radio receivers 18a, 18b, 18c for generating control signals delivered to the controller 7 for controlling the movement of the elevator car 6 according to current needs in order to improve the response of the elevator system 2 to passenger service requests and to enhance the efficiency of the elevator system 2. This in particular may result in reducing the average waiting time of the passengers 22 at the different floors 13a, 13b, 13c.

If there are floors (not shown) without a radio receiver 18a, 18b, 18c, potential passengers 22 present on said floors are not considered by the dispatcher 17 when carrying out a dispatching algorithm according to exemplary embodiments of the invention. Therefore, if any, usually only “special floors” used only by a small number of passengers 22 are not provided with radio receivers 18a, 18b, 18c.

The dispatcher 17 may be implemented in hardware, i.e. as an electronic circuit. The dispatcher 17 in particular may include an application specific integrated circuit (ASIC) customized for the respective tasks. Additionally or alternatively, the dispatcher 17 may include a programmable (micro-)processor, which is controlled by an appropriate program for executing the evaluation.

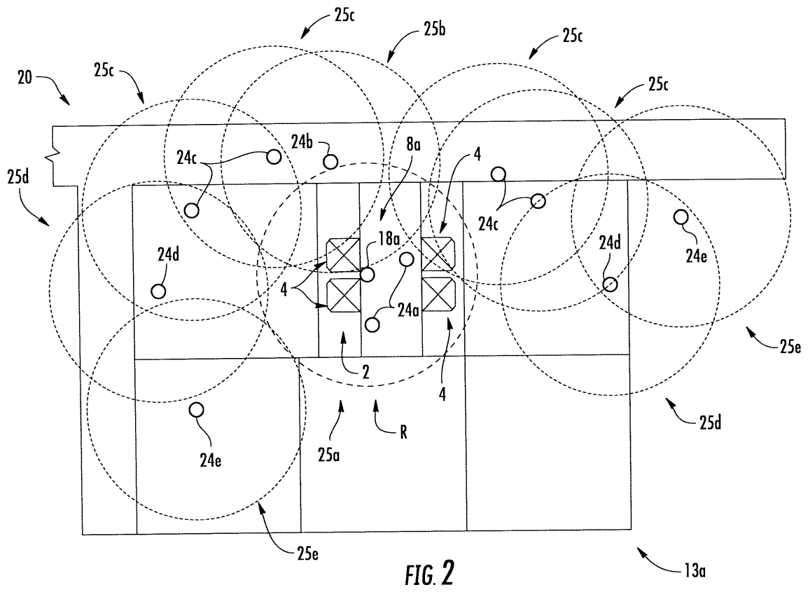

The details of said evaluation are described in the following with respect to FIG. 2.

FIG. 2 shows a schematic plan view of the first floor 13a. Although the first floor 13a is depicted in FIG. 2, the skilled person understands that the principles described on the following apply to any of the floors 13a, 13b, 13c irrespectively of the geometrical details of the respective floor 13a, 13b, 13c.

The first floor 13a comprises a landing area 8a providing access to the elevator system 2. In the example depicted in FIG. 2, the elevator system 2 comprises four hoistways 4 with at least one elevator car 6 (not shown) moving within each of the hoistways 4. The skilled person, however, will understand that the invention may be applied to elevators systems 2 comprising any number of hoistways 4 and/or elevator cars 6.

As mentioned with respect to FIG. 1, a radio receiver 18a configured for receiving radio signals from mobile devices 24a-24e is arranged at the landing area 8a.

The radio receiver 18a in particular is configured for receiving radio signals from the mobile device 24a closest to the radio receiver 18a.

In case there are a plurality of mobile devices 24a, 24b, 24c within the receiving range of the radio receiver 18a, the mobile device 24a from which the strongest signal is received may be considered to be the “closest mobile device 24a”.

Alternatively, the plurality of mobile devices 24a within the receiving range of the radio receiver 18a may be considered to constitute a group of “closest mobile devices 24a”.

Each of the mobile devices 24a-24e is configured for emitting a radio signal which may be received by a radio receiver 18a of the elevator system 2. Each of the mobile devices 24a-24e is further configured for receiving similar signals emitted by other (similar) mobile devices 24a-24e located within a receiving range 25a-25e of the respective mobile device 24a-24e. The radio signals emitted by the mobile devices 24a-24e include an identifier, which allows unambiguously identifying the at least one other mobile device. The emitted radio signals further comprise the number and the identifiers of the mobiles devices 24a-24e from which the mobile device 24a-24e emitting the radio signal itself has received radio signals. Each mobile device 24a-24e forwards the information comprised in the received radio signals by including said information into the emitted radio signal.

In consequence, by receiving radio signals from neighboring mobile devices 24a-24e and emitting radio signals including the received information, the mobile devices 24a-24e being present on the first floor 13a constitute a network 20 of mobile devices 24a-24e. Said network 20 allows the radio receiver 18a located in the landing area 8a to receive a radio signal comprising information about all mobile devices 24a-24e being present on the respective floor 13a, in particular about the total number of mobile devices 24a-24e being present on the respective floor 13a. The radio signal in particular also includes information about mobile devices 24c-24e which are arranged outside the reception range R of the radio receiver 18a itself.20

The number of data transmissions required for transferring radio signal from a mobile device 24a-24e to the radio receiver 18a is denoted as the “level” of the respective mobile device 24a-24e. I.e., the mobile device 24a located closest to the radio receiver 18a and communicating directly with the radio receiver 18a constitutes the first level, the mobile devices 24b emitting radio signals directly received by the mobile device 24a of the first level constitute the second level. The mobile devices 24c emitting radio signals directly received by the mobile device 24b of the second level but not by the mobile devices 24a of the first level constitute the third level, etc.

Due overlapping of the receiving ranges 25a-25e of the mobile devices 24a-24e, a mobile device 24a-24e may be associated with a plurality of levels. Based on the identifier comprised in each radio signal unambiguously identifying the respective mobile device 24a-24e, such duplications are identified and the respective mobile device 24a-24e is associated only with the lowest of the plurality of levels.

As a result, the radio signal received by the radio receiver 18a includes information about the distribution of the mobile devices 24a-24e over the different levels which roughly corresponds to the spatial distribution of the mobile devices 24a-24e, and thus to the spatial distribution of potential passengers 22 (not shown in FIG. 2) carrying said mobile devices 24a-24e, on the respective floor 13a.

Depending on the local characteristics of radio data transmission, mobile devices 24c-24e located on other floors 13b, 13c may be accidentally included in the network 20 as well. The errors resulting from including these additional mobile devices 24c-24e, however, are usually small and do not considerably deteriorate the result of the statistics.

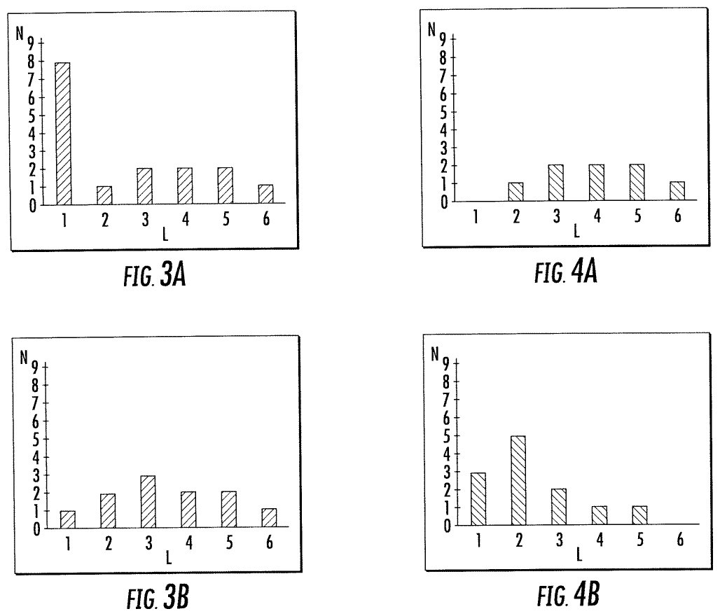

FIGS. 3A and 3B depict exemplary distributions of mobile devices 24a-24e on a first floor (FIG. 3A) and on a second floor (FIG. 3B) at a first time, e.g. 8:00 h, respectively; and FIGS. 4A and 4B depict exemplary distributions of mobile devices 24a-24e on a first floor (FIG. 3A) and on a second floor (FIG. 3B) at a second time, e.g. 8:15 h, respectively. In these figures, the different levels L are denoted on the horizontal direction, and the numbers N of mobile devices 24a-24e detected in the respective level L are denoted in the vertical direction.

At the first time (see FIGS. 3A and 3B), the number of mobile devices 24a-24e, corresponding to the number of potential passengers 22, is highest in the first level of the first floor 13a, i.e. a large number of potential passengers 22 is present on the first floor 13a and most of the potential passengers 22 are located within or close to the landing area 8 of the first floor 8a. Thus, even before the passengers 22 approaching the landing area 8a reach the landing control panel(s) 16a, 16b, 16c of the first floor 13a and are able to enter their elevator calls, the controller 7 causes at least one available elevator car 6 to move to the first floor 13a for picking up the passengers 22, thereby reducing the waiting times of said passengers 22.

At the second time (see FIGS. 4A and 4B), the number of mobile devices 24a-24e corresponding to the number of potential passengers 22 is highest in the vicinity of the landing area Sb of the second floor 13b. Thus, elevator cars 6 are sent to the second floor 13b instead of the first floor 13a for picking up passengers 22 on the 35 second floor 13b. In this case, the number of potential passengers 22 is highest in the second, but not in the first level. Thus, the potential passengers 22 on average are situated more distantly form the landing area 8b than in the situation depicted in FIG. 3A. Thus, the controller 7 has more time for moving at least one elevator car 6 to the second floor 13b and/or less elevator cars 6 are needed than in a situation as depicted in FIG. 3A, in which most potential passengers 22 are situated in the first level, i.e. within or close to the landing area 8a, 8b, 8c of the respective floor 13a, 13b, 13c.

Optionally, the evaluation of the radio signals received by the radio receivers 18a, 18b, 18c may include not only evaluating the number of mobile devices 24a-24e within the respective levels, but also temporal shifts of the mobile devices 24a-24e (potential passengers 22) between the different levels. Identifying such temporal shifts allows determining whether the detected mobile devices 24a-24e (potential passenger 22) in average approach the landing area 8a, 8b, 8c of the respective floor 13a, 13b, 13c or move away from said landing area 8a, 8b, 8c.

This allows the controller 7 not to send elevator cars 6 to floors 13a, 13b, 13c with a large number of potential passengers 22, in case these potential passengers 22 do not approach the landing area 8a, 8b, 8c of the respective floor 13a, 13b, 13c. Instead, the elevator cars 6 may be sent to another floor 13a, 13b, 13c, in particular to a floor 13a, 13b, 13c with a larger number of potential passengers 22 approaching the respective landing area 8a, Sb, 8c. As a result, the waiting times of said passengers 22 are further reduced, and the efficiency of the elevator system 2 is enhanced even more.

The mobile devices 24a-24e in particular may include smart phones and/or tablet computers running an appropriate program (“App”) for performing the desired functionalities of receiving and emitting the radio signal mentioned before.

Exemplary embodiments of the invention therefore also include a program (“App”) configured for being run on such a mobile device 14 causing the mobile device to execute said functionalities.

Such mobile devices 24a-24e and/or programs may be distributed to potential passengers 22, in particular persons frequently using the elevator system 2.

While the invention has been described with reference to exemplary embodiments, it will be understood by those skilled in the art that various changes may be made and equivalents may be substituted for elements thereof without departing from the scope of the invention. In addition, many modifications may be made to adopt a particular situation or material to the teachings of the invention without departing from the essential scope thereof. Therefore, it is intended that the invention not be limited to the particular embodiment disclosed, but that the invention include all embodiments falling within the scope of the claims.

### REFERENCES

2 elevator system

3 tension member

4 hoistway

5 drive

6 elevator car

7 elevator control

8a, 8b, 8c landing area

10a, 10b, 10c landing door

12 elevator car door

13a, 13b, 13c floor

14 elevator car control panel

16a, 16b, 16c landing control panel

17 dispatcher

18a, 18b, 18c radio receiver

20 network of mobile devices

22 passenger

24a-24e mobile devices

25a-25e receiving ranges

What is claimed is:

1. Method of controlling movement of at least one elevator car (6) in an elevator system (2), the elevator system (2) comprising at least one elevator car (6) configured for traveling along a hoistway (4) between a plurality of landing areas (8a, 8b, 8c) located at different floors (13a, 13b, 13c), wherein the method includes:
on at least a subset of the floors (13a, 13b, 13c), receiving from at least one mobile device (24a-24e) a radio signal representative of the number of potential passengers (22) on the respective floor (13a, 13b, 13c); and
controlling movement of the elevator car (6) based on the received radio signal.

2. Method according to claim 1, wherein the radio signal is a radio signal which does not require performing a handshake mechanism for establishing a data connection, in particular a Bluetooth-low-energy® radio signal or a Wi-Fi beacon frame.

3. Method according to claim 1, wherein the received radio signal comprises information representing a spatial distribution of mobile devices (24a-24e) on the respective floor (13a, 13b, 13c), and/or wherein the received radio signal comprises information representing a change of the spatial distribution of mobile devices (24a-24e) on the respective floor (13a, 13b, 13c) over time.

4. Method according to claim 1, wherein the method includes at least one mobile device (24a-24e) receiving radio signals from at least one other mobile device (24a-24e), and wherein the radio signals received from the at least one other mobile device (24a-24e) comprise information about the number of further mobile devices (24a-24e) from which radio signals have been received by the other mobile device (24a-24e) emitting the radio signals.

5. Method according to claim 4, wherein the method includes summing up the numbers of further and other mobile devices (24a-24e) comprised in the received radio signals, and including the sum into the radio signal emitted by the at least one mobile device (24a-24e).

6. Mobile device (24a-24e) configured for communicating with an elevator control system, the mobile device (24a-24e) being configured for receiving radio signals from other mobile devices (24a-24e) being present within a certain distance (d) from the mobile device (24a-24e); and for
emitting a radio signal comprising information related to the number of other mobile devices (24a-24e) from which radio signals have been received.

7. Mobile device (24a-24e) according to claim 6, wherein the radio signals are Bluetooth radio signals, in particular a Bluetooth-low-energy radio signals, and/or Wi-Fi beacon frames.

8. Mobile device (24a-24e) according to claim 6, wherein the mobile device (24a-24e) is a smartphone.

9. Mobile device (24a-24e) according to claim 6, wherein the radio signals comprise information about the number of other mobile devices (24a-24e) from which radio signal have been received by the respective mobile device (24a-24e).

10. Mobile device (24a-24e) according to claim 9, configured to sum up the numbers of other mobile devices (24a-24e) comprised in the received radio signals and to include the sum into the emitted radio signal.

11. Elevator control system configured for controlling an elevator system (2), the elevator system (2) comprising at least one elevator car (6) configured for traveling along a hoistway (4) between a plurality of floors (13a, 13b, 13c), wherein the elevator control system comprises.
a plurality of radio receivers (18a, 18b, 18c), at least one radio receiver (18a, 18b, 18c) arranged on on at least a subset of the floors (13a, 13b, 13c),
wherein every radio receiver (18a, 18b, 18c) is configured for receiving radio signals emitted from a mobile device (24a-24e) according to claim 5; and
a dispatcher (17) configured for generating control signals for controlling the movement of the elevator car (6) based on the received radio signals.

12. Elevator control system according to claim 11, wherein the dispatcher (17) is configured for controlling the elevator system (2) so that at least one elevator car (6) is moved to a landing area (8a, 8b, 8c) for which the largest number of passengers (22) has been detected as being present in the vicinity of the landing area (8a, 8b, 8c).

13. Elevator control system according to claim 11, wherein the dispatcher (17) is configured for controlling the elevator system (2) so that at least one elevator car (6) is moved to a landing area (8a, 8b, 8c) for which the largest number of passengers (22) has been detected as approaching the landing area (8a, 8b, 8c).

14. Elevator system (2) comprising at least one elevator car (6) configured of traveling along a hoistway (4) between a plurality of floors (13a, 13b, 13c), and an elevator control system according to claim 1.

15. Computer program configured for being executed on a mobile device (24a-24e), the computer program, when executed, causing the mobile device (24a-24e) to act as a mobile device (24a-24e) according to claim 6.
